(19) United States
(12) Patent Application Publication
(10) Pub. No.: US 2018/0253081 A1
(43) Pub. Date: Sep. 6, 2018

(54) Systems, Devices, and Methods for Forming Three-Dimensional Products with Embedded RFID Elements

(71) Applicant: Wal-Mart Stores, Inc., Bentonville, AR (US)

(72) Inventors: Matthew Allen Jones, Bentonville, AR (US); Aaron Vasgaard, Fayetteville, AR (US); Nicholaus Adam Jones, Fayetteville, AR (US); Robert James Taylor, Rogers, AR (US)

(21) Appl. No.: 15/876,519

(22) Filed: Jan. 22, 2018

Related U.S. Application Data
(60) Provisional application No. 62/465,557, filed on Mar. 1, 2017.

(51) Int. Cl. G05B 19/4099; G06K 19/077; G06K 19/07; B29C 64/118; B29C 64/393; B33Y 10/00; B33Y 30/00; B33Y 50/02; B33Y 70/00

(52) U.S. Cl. CPC G05B 19/4099; G06K 19/07747; G06K 19/0723; G06K 19/07792; B29C 64/118; B29K 2505/00; B33Y 10/00; B33Y 30/00; B33Y 50/02; B33Y 70/00; G05B 2219/49023; B29C 64/393

(57) ABSTRACT

A technique for forming a product with an embedded RFID element is disclosed. An extruder can extrude a first material and a second material onto a print bed. The first material has multiple RFID chips dispersed throughout the first material, and the second material has metallic particles dispersed throughout the second material to achieve a specified concentration of metallic particles. A computing system controls the extruder to print a three dimensional product on the print bed using the first extrusion material and the second extrusion material. The computing system also controls the rate at which the first material and the second material is extruded in order to electrically couple at least one of the RFID chips to at least some of the metallic particles in the three dimensional product to form an RFID tag embedded in the three dimensional product that is readable by an RFID reader.

### CROSS-REFERENCED APPLICATIONS

This application claims priority to U.S. Provisional Patent Application Ser. No. 62/465,557, entitled “SYSTEMS, DEVICES, AND METHODS FOR FORMING THREE-DIMENSIONAL PRODUCTS WITH EMBEDDED RFID ELEMENTS,” filed on Mar. 1, 2017, which is hereby incorporated by reference in its entirety.

### BACKGROUND

Additive manufacturing processes for making three dimensional products can raise a number of non-trivial challenges. These processes are capable of forming products using various types of source materials.

### SUMMARY

Embodiments of the present disclosure utilize one or more extruders of a three-dimensional (3D) printer to extrude a first material and a second material to form a three dimensional product. The first material includes at least one RFID chip within the material to be extruded by the 3D printer, and the second material includes a specified concentration of electrically conductive metallic particles to be extruded by the 3D printer. A computing system can control the one or more extruders to form an electrical connection between a contact of the RFID chip and at least one of the electrically conductive metallic particles in the second material, in order to form a functional RFID tag within the three dimensional product.

In one embodiment, a system for forming a product with an embedded RFID element is disclosed. The system includes a print bed and one or more extruders for extruding a first material and a second material. The first material has a number of RFID chips dispersed throughout the first material, and the second material has metallic particles dispersed throughout the second material to achieve a specified concentration of metallic particles. The system also includes a computing system configured to control the one or more extruders to print a three dimensional product on the print bed using the first extrusion material and the second extrusion material. The computing system is also configured to control the one or more extruders to control a rate at which the first material or the second material is extruded to electrically couple at least some of the RFID chips to at least some of the metallic particles in the three dimensional product to form a functional RFID tag embedded in the three dimensional product that is readable by an RFID reader.

In another embodiment, a method for forming a product with an embedded RFID element is disclosed. The method includes extruding, using one or more extruders, a first material having a number of RFID chips dispersed throughout the first material to achieve a specified concentration of the RFID chips within the first material. The method also includes extruding, using the one or more extruders, a second material having metallic particles dispersed throughout the second material to achieve a specified concentration of metallic particles in the second material. The method also includes controlling an operation of the one or more extruders to print a three dimensional product on a print bed using the first extrusion material and the second extrusion material. The method also includes controlling a rate at which the first material or the second material is extruded to electrically couple at least some of the RFID chips to at least some of the metallic particles as the three dimensional product is formed to form an RFID tag embedded in the three dimensional product that is readable by an RFID reader.

Additional combinations and/or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present disclosure will be more fully understood from the following description of exemplary embodiments when read together with the accompanying drawings, in which:

FIG. 1 is a flowchart illustrating an exemplary method for forming a product with an embedded RFID element, according to an embodiment of the present disclosure.

FIG. 2 is a flowchart illustrating another exemplary method for forming a product with an embedded RFID element, according to an embodiment of the present disclosure.

FIG. 3 shows an example 3D printer for printing a three dimensional product with an RFID tag embedded within it, in accordance with an exemplary embodiment.

FIG. 4 is a diagram of an exemplary network environment suitable for a distributed implementation of an exemplary embodiment of the present disclosure.

FIG. 5 is a block diagram of an exemplary computing device that can be used to perform exemplary processes in accordance with an exemplary embodiment of the present disclosure.

### DETAILED DESCRIPTION

Following below are more detailed descriptions of various concepts related to, and embodiments of, inventive methods, devices, and systems for forming a product with an embedded RFID element via a 3D printer. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to”, the term “including” means “including but not limited to”. The term “based on” means “based at least in part on”.

In accordance with some embodiments of the present disclosure, methodologies, systems, apparatus, and non-transitory computer-readable media are described herein to facilitate forming a product with an embedded RFID element. In exemplary embodiments, a three dimensional product can be formed using any number of additive manufacturing techniques, and the present disclosure is not limited to any particular type of additive manufacturing technique, unless otherwise specified. Examples of additive manufacturing techniques include, for example, selective heat sintering, selective laser melting, selective laser sintering, direct metal laser sintering, fused deposition modeling, fused filament fabrication, stereolithography, direct ink writing or robocasting, electron-beam melting, directed energy deposition, and electron beam freeform fabrication.

In one example embodiment, an extruder of a 3D printer extrudes a first material onto a print bed to form a three dimensional product, and the first material includes one or more RFID chips. As the first material is extruded to form the three dimensional product, at least one of the RFID chips is extruded with the first material. The RFID chip can be disposed at a specific location within the first material and/or the first material can include a specified concentration of RFID chips. The one or more RFID chips can each be, for example, between about 0.4 mm to about 1.0 mm in size and can have a number of electrical contacts on different sides of the RFID chip for making an electrical connection with an RFID tag antenna. The one or more RFID chips can include circuitry for storing, transmitting, and receiving data, but can be incapable of being read by an RFID reader due to the lack of an antenna. Once the one or more RFID chips in the first material are extruded onto the three dimensional product, the extruder can extrude an electrically conductive second material to form electrical connections with one or more of the contacts of the one or more RFID chips. In some embodiments, the conductive second material can be a polymer material that includes a sufficiently high concentration of metallic flake particles to make it electrically conductive. The extruder can deposit the conductive second material to form an antenna pattern within the three dimensional product. Once the conductive material forms an electrical contact with the one or more RFID chips, the conductive material can form an antenna for the RFID chip(s) to form a functioning RFID tag that is capable of being read by an RFID reader.

In some embodiments, the antenna pattern can be determined in order to minimize deviation from a straight line within the three dimensional product or based on a desired frequency band for the RFID tag. For example, the length of the antenna can be 1/4 the wavelength of the desired frequency of the RFID tag. In one non-limiting example embodiment, the length of the antenna for an RFID tag tuned to 915 MHz can be about 78 mm. The antenna pattern can also be optimized, in some embodiments, so that the RFID tag can be read from multiple angles. For example, flat RFID tags are generally best read when scanned head-on. However, different bends and angles in the antenna pattern can result in an RFID tag that can be read from multiple angles. These antenna pattern orientations and configurations can be produced using the extrusion techniques described herein. In some embodiments, the RFID chip(s) can be programmed with an authentication code prior to being extruded within the three dimensional product by the extruder. The authentication code can be used, for example, to authenticate the three dimensional product once it is printed by the 3D printer. As will be appreciated, the 3D printer can be located at a store, in some embodiments, or a user can use his or her own 3D printer to manufacture the three dimensional product using a 3D printer file and an authentication code provided by a vendor.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

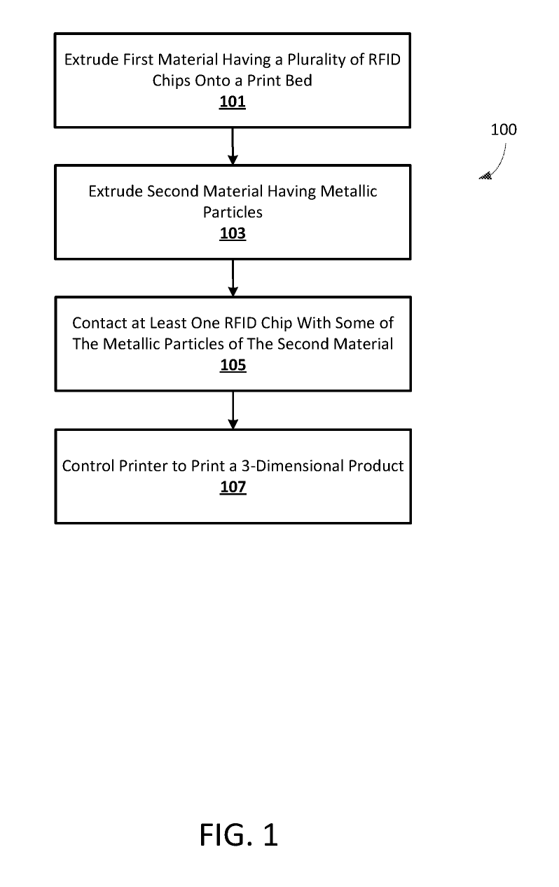

FIG. 1 is a flowchart illustrating a method 100 for forming a product with an embedded RFID element, in accordance with an exemplary embodiment. It will be appreciated that the method is programmatically performed by one or more computer-executable processes executing on, or in communication with, one or more computing systems or servers described further below. In step 101, one or more extruders of a 3D printer are used to extrude a first material onto a print bed. The first material has a number of RFID chips dispersed throughout the material to achieve a specified concentration of the RFID chips within the first material. In some embodiments, the first material can initially be in the form of a spool or filament, and the RFID chips can be dispersed at predetermined distances within the spool. The first material can include, for example, various types of plastics, charged plastics, resins, ceramics, or any other material suitable for extruding with a 3D printer to form a three dimensional product. In some embodiments, each RFID chip is between about 0.4 mm to about 1.0 mm in size and can have a number of contacts on different sides of the RFID chip for making an electrical connection with an RFID tag antenna.

In step 103, the one or more extruders of the 3D printer are used to extrude a second material having metallic particles dispersed throughout the second material to achieve a specified concentration of metallic particles in the second material. In some embodiments, the second material is a polymer material that includes a sufficiently high concentration of metallic flake particles that allows the second material to be electrically conductive once it is extruded from the one or more extruders. In some embodiments, the second material can be provided in the form of a spool or filament that is received by a 3D printer. The second material can be extruded using the same extruder or printer head as used for the first material. Alternatively, separate extruders can be used for the first material and the second material in some embodiments.

In step 105, a computing system controls a rate and/or timing at which the first material and the second material are extruded in order to electrically couple at least some of the RFID chips being extruded with the first material with at least some of the metallic particles of being extruded with the second material. As discussed above, the second material includes a sufficient proportion of metallic particles to be electrically conductive, and the one or more extruders can accurately print the second material such that it creates a connection with at least one electrical contact on at least one of the RFID chips to form a functional RFID tag embedded in the three dimensional product that is readable by an RFID reader.

In step 107, the computing system controls a rate and/or timing at which the first material and the second material are extruded to print a three dimensional product on the print bed using the first material and the second material. In some embodiments, a 3D printer can extrude the first material from an extruder or printer head until the moment when one of the RFID chips embedded within the first material is expected to be extruded onto the print bed (e.g., based on a concentration of RFID chips in the first material and/or based on known locations of the RFID chips in the first material. Before, during, and/or after one of the RFID chips within the first material is extruded into the three dimensional product, the 3D printer can switch materials and extrude the second material to form an antenna arrangement for electrical connection with one of the contacts of the RFID chip and/or can simultaneously coextrude the first and second materials to form the antenna arrangement and the electrical connection between the antenna arrangement and the RFID chip. After printing the antenna portion of the RFID tag using the second material, the computing system can control the extruder to complete the formation of the three dimensional product using the first material, or any other material needed to print the three dimensional product. In exemplary embodiments, the 3D printer can be controlled to extrude several RFID chips and several antenna portion in a single three dimensional product to improve the probability that at least one functional RFID tag is formed.

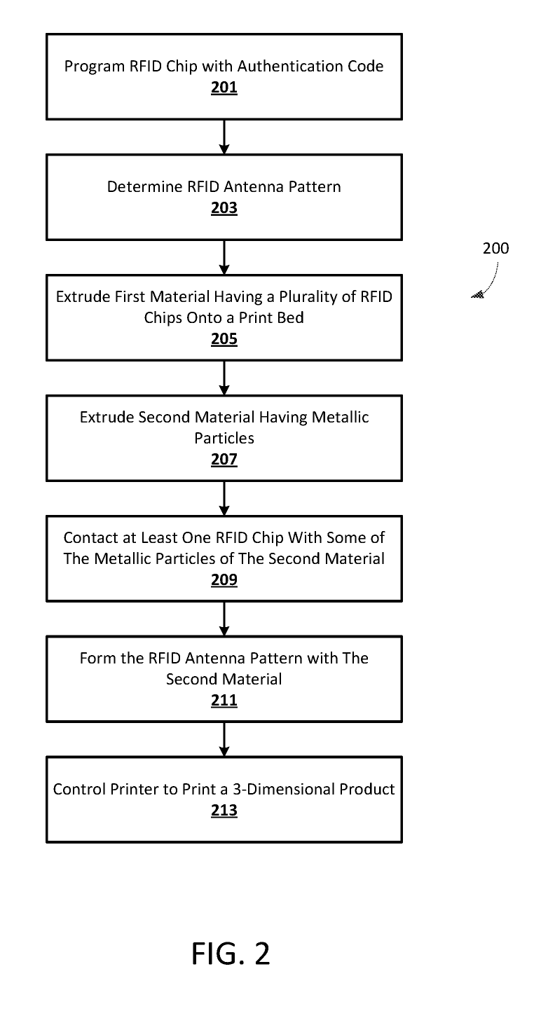

FIG. 2 is a flowchart illustrating a method 200 for forming a product with an embedded RFID element, in accordance with an exemplary embodiment. It will be appreciated that the method is programmatically performed by one or more computer-executable processes executing on, or in communication with, one or more computing systems or servers described further below. In step 201, one or more RFID chips are programmed, via an RFID programming module, with an authentication code prior to being printed within a three dimensional product. In some embodiments, a number of RFID chips are dispersed throughout a first extrusion material to achieve a specified concentration of RFID chips within the first extrusion material. The RFID chips can be programmed with an authentication code that can be used to authenticate the three dimensional product once it is printed using a 3D printer, as discussed herein.

In step 203, an antenna pattern module determines an antenna pattern for the RFID tag that will be embedded within the three dimensional product. In some embodiments, the antenna pattern is determined in order to minimize deviation from a straight line within the three dimensional product. For example, if the three dimensional product has an elongated form factor, an elongated antenna pattern may be determined in order to take advantage of the dimensions of the three dimensional product and minimize the number of bends or turns in the antenna pattern. In some embodiments, the antenna pattern is determined based on a desired frequency band for the RFID tag. For example, the length of the antenna can be ¼ the wavelength of the desired frequency of the RFID tag. In one non-limiting example embodiment, the length of the antenna for an RFID tag tuned to 915 MHz can be about 78 mm. As will be appreciated, different antenna lengths can be implemented corresponding to different desired frequencies of the RFID tag.

In step 205, one or more extruders of the 3D printer are used to extrude the first material onto a print bed. As discussed above, the first material has a number of RFID chips dispersed throughout the material to achieve a specified concentration of the RFID chips within the first material. In some embodiments, the 3D printer can be configured to receive a spool of the first extrusion material that can be melted and extruded from an extruder to form the desired three dimensional product. The first extrusion material can have a number of RFID chips dispersed at predetermined distances within the spool such that the computing system associated with the 3D printer knows or estimates when each RFID chip will be extruded onto the three dimensional product. The first material can include, for example, various types of plastics, charged plastics, resins, ceramics, or any other material suitable for extruding with a 3D printer to form a three dimensional product. In some embodiments, each RFID chip is between about 0.4 mm to about 1.0 mm in size and can have a number of contacts on different sides of the RFID chip for making an electrical connection with an RFID tag antenna.

In step 207, the one or more extruders of the 3D printer are used to extrude a second material having metallic particles dispersed throughout to achieve a specified concentration of metallic particles in the second material. In some embodiments, the second material is a polymer material that includes a sufficiently high concentration of metallic flake particles that allows the second material to be electrically conductive once it is extruded from the one or more extruders. In some embodiments, the 3D printer can receive a spool or filament of the second material, and the second material can be extruded in order to form an electrical connection with a contact of one of the RFID chips extruded within the first material. In some embodiments, the second material can be extruded using the same extruder or 3D printer head as used for the first material, or a separate extruder can be used.

In step 209, the computing system associated with the 3D printer controls a rate and/or timing at which the first material and the second material are extruded in order to electrically couple at least some of the RFID chips extruded from within the first material with at least some of the metallic particles of the second material. As discussed above, the second material includes a sufficient proportion of metallic particles to be electrically conductive, and the one or more extruders can accurately print the second material such that it creates a connection with at least one electrical contact on one of the RFID chips to form an RFID tag embedded in the three dimensional product that is readable by an RFID reader.

In step 211, the computing system associated with the 3D printer controls the extrusion of the second material from the one or more extruders to form an antenna in the three dimensional product according to the antenna pattern determined in step 203. In some embodiments, the antenna pattern can be oriented within the three dimensional product to reduce bends or turns in the antenna.

In step 213, the computing system associated with the 3D printer controls a rate at which the first material and the second material are extruded to print a three dimensional product on the print bed using the first material and the second material, with the antenna embedded within the three dimensional product. In some embodiments, the 3D printer can extrude the first material from an extruder or printer head until the moment when one of the RFID chips embedded within the first material is extruded within the three dimensional product. Once one of the RFID chips within the first material is extruded into the three dimensional product, the 3D printer begin extruding the second material to form an electrical connection with one of the contacts of the RFID chip. For example, in some embodiments, the 3D printer can switch from extruding the first material to extruding the second material and/or the 3D printer can simultaneously extrude the first and second material. After printing the antenna portion of the RFID tag using the second material, the computing system can control the extruder to complete the formation of the three dimensional product using the first material, or any other material needed to print the three dimensional product. In exemplary embodiments, the 3D printer can be controlled to extrude several RFID chips and several antenna portion in a single three dimensional product to improve the probability that at least one functional RFID tag is formed.

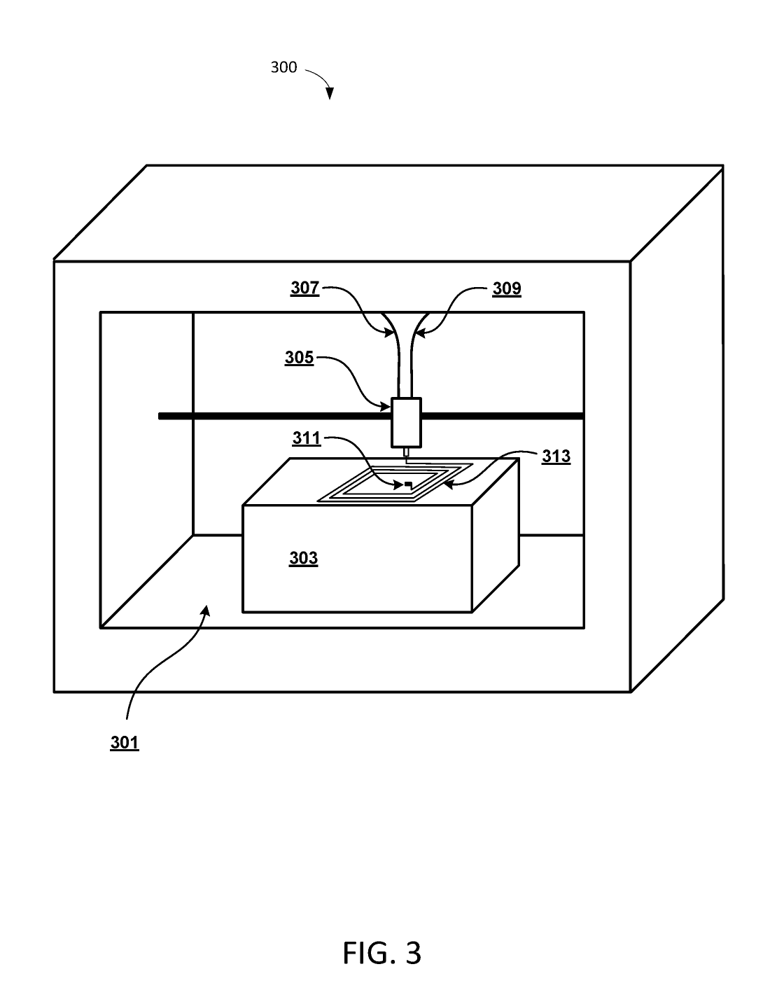

FIG. 3 shows an example 3D printer 300 for printing a three dimensional product 303 with an RFID tag embedded, in accordance with an exemplary embodiment. In this example embodiment, the 3D printer 300 includes an extruder 305 or 3D printer head that is configured to receive a spool or filament of a first material 307 and a second material 309. The extruder 305 can selectively extrude the first material 307 and the second material 309 in order to print the three dimensional product 303 on the print bed 301 and/or can coextrude the first and second materials. As discussed above, the first material 307 can include a number of RFID chips embedded within it at predetermined distances such that the system knows or estimates when one of the RFID chips is going to be placed in the three dimensional product 303 by the extruder 305. In this example embodiment, an RFID chip 311 has been placed on the three dimensional product 303, and the extruder 305 has begun extruding the second material 309 to form an antenna pattern 313. Alternatively, the system can estimate when the RFID chips are being extruded based on a concentration of the RFID chips in the first material and/or can extrude the first material without controlling the extrusion based on the knowledge of the location or concentration of the RFID chips in the first material, and the second material can be extruded by the 3D printer (e.g., based on the control from the computing system) at a rate or timing that is determined based on a concentration of the RFID chips in the first material using a statistical or probabilistic approach.

As discussed above, the antenna pattern 313 can be determined in order to minimize deviation from a straight line within the three dimensional product 303 or based on a desired frequency band for the RFID tag. In some embodiments, the RFID chip 311 can be programmed with an authentication code prior to being extruded within the three dimensional product 303 by the extruder 305. The authentication code can be used, for example, to authenticate the three dimensional product 303 once it is printed by the 3D printer 300. As will be appreciated, the 3D printer 300 can be located at a store, in some embodiments, or a user can use his or her own 3D printer to manufacture the three dimensional product 303 using a 3D printer file and an authentication code provided by a vendor.

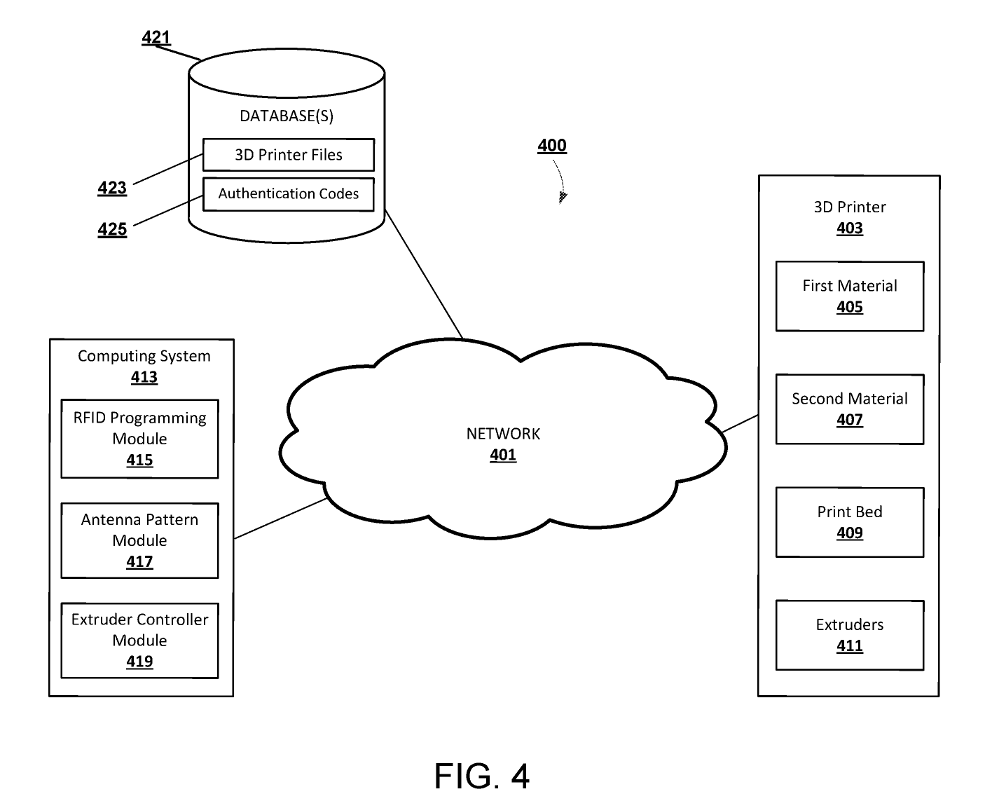

FIG. 4 illustrates a network diagram depicting a system 400 suitable for a distributed implementation of exemplary embodiments. The system 400 can include a network 401, and a 3D printer 403 configured to receive a first material 405 and a second material 407 and including a print bed 409 and one or more extruders 411. The system 400 may also include a computing system 413 and a database 421. As will be appreciated, various distributed or centralized configurations may be implemented. In exemplary embodiments, the computing system 413 can store an RFID programming module 415, an antenna pattern module 417, and an extruder controller module 419, which can implement one or more of the processes described herein with reference to FIGS. 1-2, or portions thereof. It will be appreciated that the module functionality may be combined or divided as a greater or lesser number of modules than illustrated, and that the same computing system or server could host one or more modules. The database 421 can store the 3D printer files 423 and authentication codes 425, in exemplary embodiments.

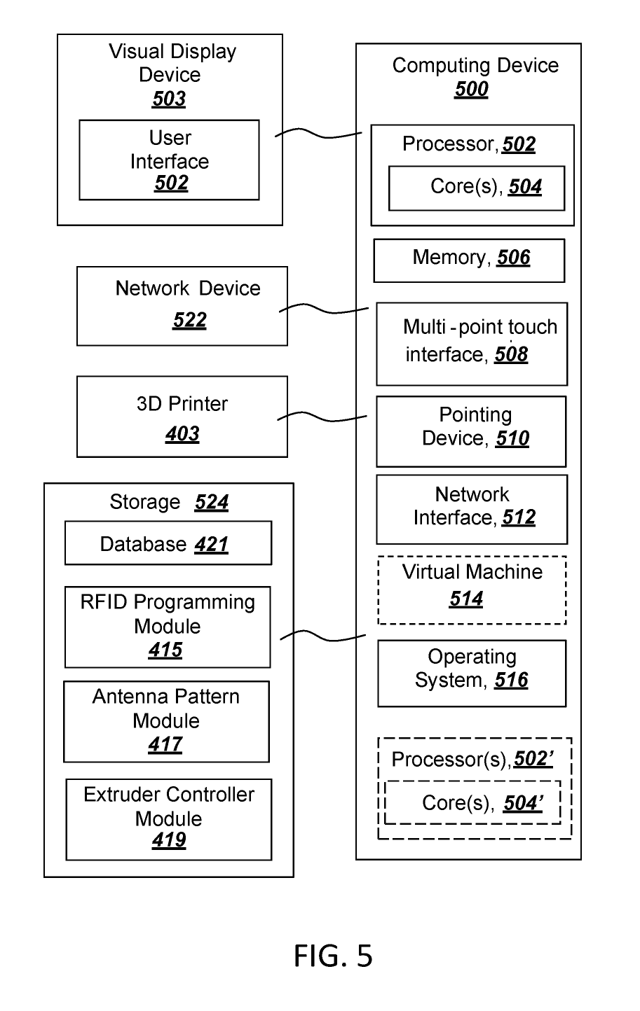

The 3D printer, computing system 413, and the database 421 may connect to the network 401 and be in communication with each other via a wired or wireless connection, in some embodiments. In some embodiments, the computing system 413 can communicate with the 3D printer 403 and the database 421 in order to control the one or more extruders 411, as described above. The computing system 413 may include some or all components described in relation to computing device 500 shown in FIG. 5.

The communication network 401 may include, but is not limited to, the Internet, an intranet, a LAN (Local Area Network), a WAN (Wide Area Network), a MAN (Metropolitan Area Network), a wireless network, an optical network, and the like. In some embodiments, the 3D printer 403, computing system 413, and the database 421 can transmit instructions to each other over the communication network 401. In exemplary embodiments, the 3D printer files 423 and the authentication codes 425 can be stored at the database 421 and received at the computing system 413 in response to a service performed by a database retrieval application.

FIG. 5 is a block diagram of an exemplary computing device 500 that can be used in the performance of any of the example methods according to the principles described herein. The computing device 500 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 506 included in the computing device 500 can store computer-readable and computer-executable instructions or software for implementing exemplary embodiments performing processes described above in reference to FIGS. 1-2. The computing device 500 also includes processor 502 and associated core 504, and optionally, one or more additional processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ can each be a single core processor or multiple core (504 and 504′) processor.

Virtualization can be employed in the computing device 500 so that infrastructure and resources in the computing device can be shared dynamically. A virtual machine 514 can be provided to handle a process running on multiple processors so that the process appears to be using only one computing resource rather than multiple computing resources. Multiple virtual machines can also be used with one processor.

Memory 506 can be non-transitory computer-readable media including a computer system memory or random access memory, such as DRAM, SRAM, EDO RAM, and the like. Memory 506 can include other types of memory as well, or combinations thereof.

A user can interact with the computing device 500 through a visual display device 503, such as an e-paper display, a LED display, an OLED display, a LCD, a touch screen display, or computer monitor, which can display one or more user interfaces 502 that can be provided in accordance with exemplary embodiments. The computing device 500 can also include other I/O devices for receiving input from a user, for example, a keyboard or any suitable multi-point touch interface 508, a pointing device 510 (e.g., a pen, stylus, mouse, or trackpad). The multi-point touch interface 508 and the pointing device 510 can be coupled to the visual display device 503. The computing device 500 can include other suitable conventional I/O peripherals.

The computing device 500 can also be in communication with 3D printer 403 and one or more storage devices 524; such as a hard-drive, CD-ROM, or other non-transitory computer readable media, for storing data and computer-readable instructions and/or software, such as an RFID programming module 415, an antenna pattern module 417, and an extruder controller module 419 that can implement exemplary embodiments of the methods and systems as taught herein, or portions thereof. Exemplary storage device 524 can also store one or more databases 421 for storing any suitable information required to implement exemplary embodiments. The databases 421 can be updated by a user or automatically at any suitable time to add, delete, or update one or more items in the databases. Exemplary storage device 524 can store one or more databases 421 for storing the 3D printer files 423 and the authentication codes 425 used to implement exemplary embodiments of the systems and methods described herein.

The computing device 500 can include a network interface 512 configured to interface via one or more network devices 522 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 512 can include a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 500 can run an operating system 516, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or any other operating system capable of running on the computing device and performing the operations described herein. In exemplary embodiments, the operating system 516 can be run in native mode or emulated mode. In an exemplary embodiment, the operating system 516 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system of forming a product with an embedded RFID element, the system comprising:
a print bed;
one or more extruders, the one or more extruders extruding a first material having a plurality of RFID chips dispersed throughout the first material to achieve a specified concentration of the plurality of RFID chips within the first material, and extruding a second material having metallic particles dispersed throughout the second material to achieve a specified concentration of metallic particles in the second material; and
a computing system configured to control the one or more extruders to:
control an operation of the one or more extruders to print a three dimensional product on the print bed using the first extrusion material and the second extrusion material, and
control a rate at which the first material or the second material is extruded to electrically couple at least some of the RFID chips to at least some of the metallic particles in the three dimensional product to form an RFID tag embedded in the three dimensional product that is readable by an RFID reader.

2. The system of claim 1, wherein the computing system is further configured to control the extrusion of the second material from the one or more extruders to form an antenna pattern in the three dimensional product with the metallic particles.

3. The system of claim 2, wherein the computing system is further configured to determine the antenna pattern to minimize deviation from a straight line within the three dimensional product.

4. The system of claim 2, wherein the computing system is further configured to determine the antenna pattern based on a desired frequency band.

5. The system of claim 1, wherein the one or more extruders includes a single extruder configured to receive a spool of the first material and a spool of the second material.

6. The system of claim 1, wherein the one or more extruders includes a first extruder configured to receive a spool of the first material and a second extruder configured to receive a spool of the second material.

7. The system of claim 1, wherein each of the plurality of RFID chips is between about 0.4 mm to about 1.0 mm in size.

8. The system of claim 1, wherein at least one of the RFID chips is programmed with an authentication code prior to being printed within the three dimensional product.

9. A method for forming a product with an embedded RFID element, the method comprising:
extruding, using one or more extruders, a first material having a plurality of RFID chips dispersed throughout the first material to achieve a specified concentration of the plurality of RFID chips within the first material;
extruding, using the one or more extruders, a second material having metallic particles dispersed throughout the second material to achieve a specified concentration of metallic particles in the second material;
controlling an operation of the one or more extruders to print a three dimensional product on a print bed using the first extrusion material and the second extrusion material; and
controlling a rate at which the first material or the second material is extruded to electrically couple at least some of the RFID chips to at least some of the metallic particles in the three dimensional product to form an RFID tag embedded in the three dimensional product that is readable by an RFID reader.

10. The method of claim 9, further comprising controlling the extrusion of the second material from the one or more extruders to form an antenna pattern in the three dimensional product with the metallic particles.

11. The method of claim 10, further comprising determining the antenna pattern to minimize deviation from a straight line within the three dimensional product.

12. The method of claim 10, further comprising determining the antenna pattern based on a desired frequency band.

13. The method of claim 9, wherein the one or more extruders includes a single extruder configured to receive a spool of the first material and a spool of the second material.

14. The method of claim 9, wherein the one or more extruders includes a first extruder configured to receive a spool of the first material and a second extruder configured to receive a spool of the second material.

15. The method of claim 9, wherein the RFID chip is between about 0.4 mm to about 1.0 mm in size.

16. The method of claim 9, wherein the RFID chip is programmed with an authentication code prior to being printed within the three dimensional product.

17. A non-transitory machine readable medium storing instructions executable by a processing device, wherein execution of the instructions causes the processing device to implement a method for forming a product with an embedded RFID element, the method comprising:
extruding, using one or more extruders, a first material having a plurality of RFID chips dispersed throughout the first material to achieve a specified concentration of the plurality of RFID chips within the first material;
extruding, using the one or more extruders, a second material having metallic particles dispersed throughout the second material to achieve a specified concentration of metallic particles in the second material;
controlling an operation of the one or more extruders to print a three dimensional product on a print bed using the first extrusion material and the second extrusion material; and
controlling a rate at which the first material or the second material is extruded to electrically couple at least some of the RFID chips to at least some of the metallic particles in the three dimensional product to form an RFID tag embedded in the three dimensional product that is readable by an RFID reader.

18. The non-transitory machine readable medium of claim 17, wherein execution of the instructions further causes the processing device to control the extrusion of the second material from the one or more extruders to form an antenna pattern in the three dimensional product with the metallic particles.

19. The non-transitory machine readable medium of claim 18, wherein execution of the instructions further causes the processing device to determine the antenna pattern to minimize deviation from a straight line within the three dimensional product.

20. The non-transitory machine readable medium of claim 17, wherein the RFID chip is programmed with an authentication code prior to being printed within the three dimensional product.
